(19) United States
(12) Patent Application Publication
(10) Pub. No.: US 2018/0329211 A1
(43) Pub. Date: Nov. 15, 2018

(54) VIRTUAL REALITY SYSTEM SIMULATING SENSING SIGNAL OF PORTABLE DEVICE AND CONTROLLING METHOD THEREOF

(71) Applicant: Acer Incorporated, New Taipei City (TW)

(72) Inventors: Chao-Kuang Yang, New Taipei City (TW); Hung-Chih Yu, New Taipei City (TW)

(21) Appl. No.: 15/701,503

(22) Filed: Sep. 12, 2017

(30) Foreign Application Priority Data
May 12, 2017 (TW) 106115729

(51) Int. Cl. G02B 27/01; A63F 13/30; G02B 27/00; G06F 3/01; A63F 13/21

(52) U.S. Cl. CPC G02B 27/0172; A63F 13/30; A63F 2300/8082; G06F 3/011; A63F 13/21; G02B 27/0093

(57) ABSTRACT

A virtual reality system simulating a sensing signal of a portable device and a controlling method thereof are provided. The controlling method of virtual reality system includes the following steps: A first sensing signal is obtained by a head-mounted display. The first sensing signal is translated to be a second sensing signal. An original display content is adjusted to be an adjusted display content by a portable device according to the second sensing signal. The adjusted display content is transmitted to the head-mounted display, and is displayed by the head-mounted display.

This application claims the benefit of Taiwan application Serial No. 106115729, filed May 12, 2017, the disclosure of which is incorporated by reference herein in its entirety.

### TECHNICAL FIELD

The disclosure relates in general to a virtual reality system and a controlling method thereof, and more particularly to a virtual reality system simulating a sensing signal of a portable device and a controlling method thereof.

### BACKGROUND

Along with the development of a virtual reality (VR) technology, various software and hardware products of the virtual reality are provided one after another. The virtual reality technology generates a 3D virtual world through a computer simulation, which simulates user's visual faculty and provides a sense of immediacy to the user.

When the user moves or rotates, the computer immediately performs complicated computation and feeds back an accurate 3D image which provides a sense of immediacy to the user. The virtual reality technology integrates the computer simulation, the sensing, the displaying, the computer graphics, and the artificial intelligence, and has become a new focus of technology.

Currently, a cardboard is provided. The user can place a smart phone on the cardboard. When the user wears the cardboard on his/her head and rotates, the display content of the smart phone changes accordingly to provide a panoramic sense of the space to the user.

Since the sensing unit of the smart phone can generate only limited effect and the smart phone is not suitable to be too close to the eyes, the development in the technology of the cardboard is restricted.

### SUMMARY

The disclosure is directed to a virtual reality system and a controlling method thereof. Through the use of a head-mounted display device simulating a sensing signal of a portable device, the virtual reality system combines the advantage of the portable device having versatile display resources and the advantage of the head-mounted display device having high performance in image resolution and high signal tracking and sensing.

According to one embodiment, a controlling method of a virtual reality system is provided. The controlling method of the virtual reality system includes the following steps: A first sensing signal is obtained by a head-mounted display. The first sensing signal is translated to be a second sensing signal. An original display content is adjusted to be an adjusted display content by a portable device according to the second sensing signal. The adjusted display content is transmitted to the head-mounted display, and is displayed by the head-mounted display.

According to another embodiment, a virtual reality system is provided. The virtual reality system includes a head-mounted display unit, a tracking unit, a translation unit and an image processing unit. The tracking unit obtains a first sensing signal. The translation unit translates the first sensing signal to be a second sensing signal. The image processing unit may adjust an original display content to be an adjusted display content according to the second sensing signal. The head-mounted display unit and the tracking unit are disposed within the head-mounted display device. The image processing unit is disposed within a portable device. The adjusted display content is transmitted to the head-mounted display unit, such that the head-mounted display unit displays the adjusted display content.

According to another embodiment, a head-mounted display device is provided. The head-mounted display device includes a head-mounted display unit, a tracking unit, a translation unit and a transmitting unit. The tracking unit obtains a first sensing signal. The translation unit translates the first sensing signal to be a second sensing signal. The transmitting unit transmits the second sensing signal to a portable device, such that an original display content is adjusted to be an adjusted display content according to the second sensing signal. The transmitting unit further receives the adjusted display content, such that the head-mounted display unit displays the adjusted display content.

According to another embodiment, a host is provided. The host includes a transmitting unit and a translation unit. The transmitting unit receives a first sensing signal of a head-mounted display device. The translation unit translates the first sensing signal to be a second sensing signal. The transmitting unit further transmits the second sensing signal to a portable device, such that the portable device may adjust an original display content to be an adjusted display content according to the second sensing signal. The transmitting unit further transmits the adjusted display content to the head-mounted display device, such that the head-mounted display device displays the adjusted display content.

According to another embodiment, a portable device is provided. The portable device includes a transmitting unit, a translation unit and an image processing unit. The transmitting unit receives a first sensing signal of a head-mounted display device. The translation unit translates the first sensing signal to be a second sensing signal. The image processing unit may adjust an original display content to be an adjusted display content according to the second sensing signal. The transmitting unit further transmits the adjusted display content to the head-mounted display device, such that the head-mounted display device displays the adjusted display content.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 is a block diagram of a virtual reality system according to an embodiment of the invention.

FIG. 2 is a flowchart of a controlling method of the virtual reality system according to an embodiment of the invention.

FIG. 3 is a block diagram of the virtual reality system according to another embodiment of the invention.

FIG. 4 is a flowchart of a controlling method of the virtual reality system according to another embodiment of the invention.

FIG. 5 is a block diagram of a virtual reality system according to another embodiment of the invention.

FIG. 6 is a flowchart of a controlling method of the virtual reality system according to another embodiment of the invention.

### DETAILED DESCRIPTION

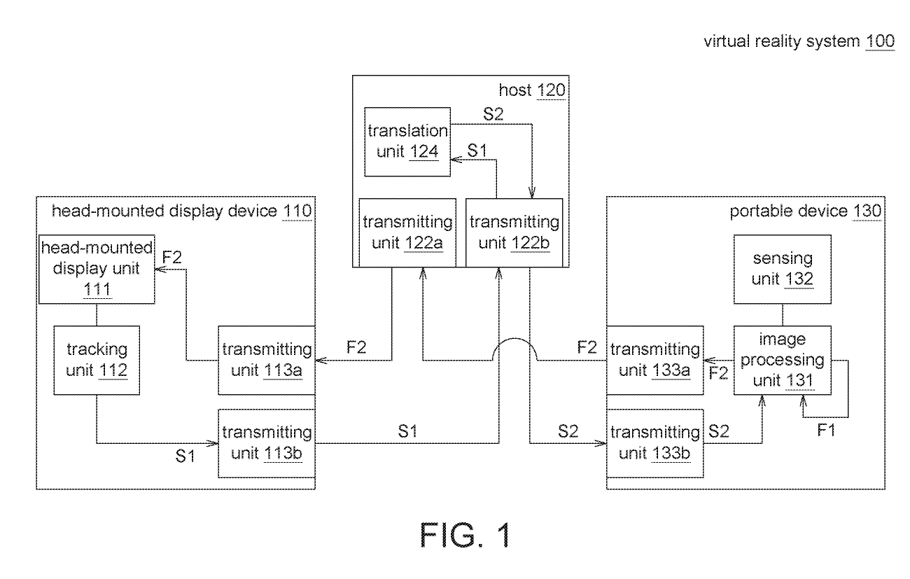

Referring to FIG. 1, a block diagram of a virtual reality system 100 according to an embodiment of the invention is shown. As indicated in FIG. 1, the virtual reality system 100 includes a head-mounted display device 110, a host 120 and a portable device 130. The head-mounted display device 110 can be realized by such as an eye mask or a helmet. The host 120 can be realized by such as a desktop computer, a server, a notebook computer, a smart phone, a cloud computation center, a chip, or a circuit board. The portable device 130 can be realized by such as a smart phone, a PC tablet, or a notebook computer.

The head-mounted display device 110 includes a head-mounted display unit 111, a tracking unit 112, a transmitting unit 113a and a transmitting unit 113b. The host 120 includes a translation unit 124, a transmitting unit 122a and a transmitting unit 122b. The portable device 130 includes an image processing unit 131, a sensing unit 132, a transmitting unit 133a and a transmitting unit 133b. The head-mounted display unit 111 displays various contents. The tracking unit 112 tracks the position and direction of the head-mounted display device 110 by way of outside-in tracking or inside-out tracking. Normally, the tracking unit 112 of the head-mounted display device 110 has a higher sensing accuracy than the sensing unit 132 of the portable device 130. The transmitting units 113a, 113b, 122a, 122b, 133a, and 133b transmit the signals. The transmitting units 113a, 113b, 122a, 122b, 133a, and 133b also can be used to transform signals (such as image processing) to achieve higher efficiency and quality of signal transmission between different devices. Each of the transmitting units 113a, 113b, 122a, 122b, 133a, and 133b can be realized by such as a wireless transmission module or a wired transmission module. The translation unit 124 is used for performing signal translation. The translation unit 124 can be realized by such as a chip, a circuit board, a circuit or a storage device storing several programming codes.

In the present embodiment, the first sensing signal S1 obtained by the tracking unit 112 is translated to be a second sensing signal S2 by the translation unit 124. The second sensing signal S2 is a simulation signal of the sensing unit 132 of the portable device 130. The image processing unit 131 of the portable device 130 can transform an original display content F1 to be an adjusted display content F2 according to the second sensing signal S2. The adjusted display content F2 can be the original display content F1 (that is, the adjusted display content F2 is equivalent to the original display content F1). Thus, when the user wears the head-mounted display device 110 and rotates his/her head, the portable device 130 will correspondingly perform rotation, movement, enlargement, and interpolation with respect to the original display content F1, and then directly output the adjusted display content F2.

The user does not really move or rotate the portable device 130, but the portable device 130 may adjust the original display content F1 according to the movement or rotation of the head-mounted display device 110. The virtual reality system 100 combines the advantage of the portable device 130 having versatile display resources and the advantage of the head-mounted display device 110 having high performance in image resolution and high signal tracking and sensing.

In the present embodiment, the translation unit 124 is disposed within the host 120. In other embodiments, the translation unit 124 can also be disposed within the portable device 130 or the head-mounted display device 110. Or, several image processing units are disposed within the host 120, the portable device 130 and the head-mounted display device 110.

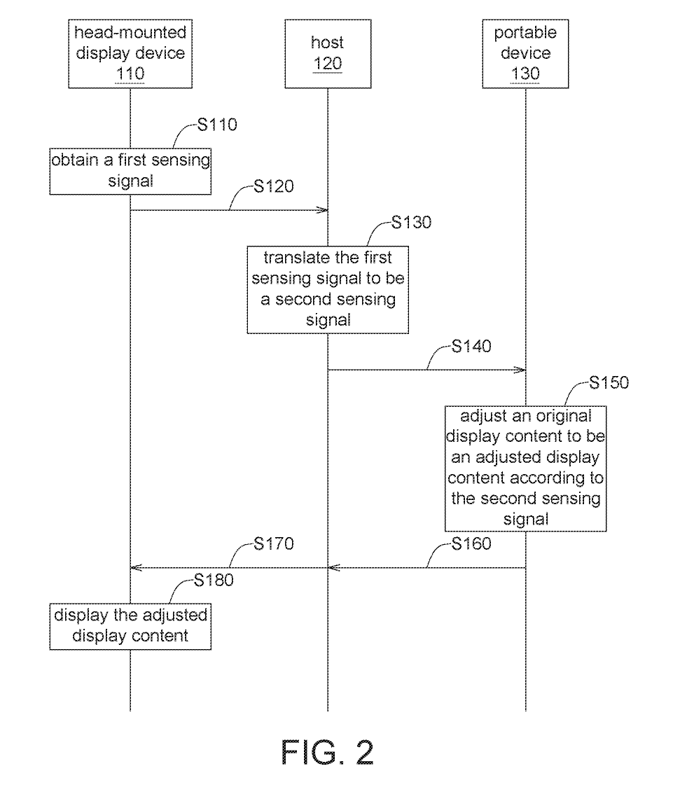

The operations of the above elements are described below with accompanying drawings. Referring to FIG. 2, a flowchart of a controlling method of the virtual reality system 100 according to an embodiment of the invention is shown. Firstly, the method begins at step S110, a first sensing signal S1 is obtained by the tracking unit 112 of the head-mounted display device 110.

Then, the method proceeds to step S120, the first sensing signal S1 is transmitted to the host 120 by the head-mounted display device 110.

After that, the method proceeds to step S130, the first sensing signal S1 is translated to be a second sensing signal S2 by the translation unit 124 of the host 120.

Then, the method proceeds to step S140, the second sensing signal S2 is transmitted to the portable device 130 by the host 120.

After that, the method proceeds to step S150, the original display content F1 is adjusted to be an adjusted display content F2 (or, the original display content F1 is not adjusted) by the image processing unit 131 of the portable device 130 according to the second sensing signal S2.

Then, the method proceeds to step S160, the adjusted display content F2 is transmitted to the host 120 by the portable device 130.

After that, the method proceeds to step S170, the adjusted display content F2 is transmitted to the head-mounted display device 110 by the host 120.

Then, the method proceeds to step S180, the adjusted display content F2 is displayed by the head-mounted display unit 111 of the head-mounted display device 110.

In the present embodiment, the tracking step (step S110) is performed by the head-mounted display device 110; the translating step (step S130) is performed by the host 120; the display content adjusting step (step S150) is performed by the portable device 130. The head-mounted display device 110, the host 120 and the portable device 130 together complete the operations of the virtual reality system 100.

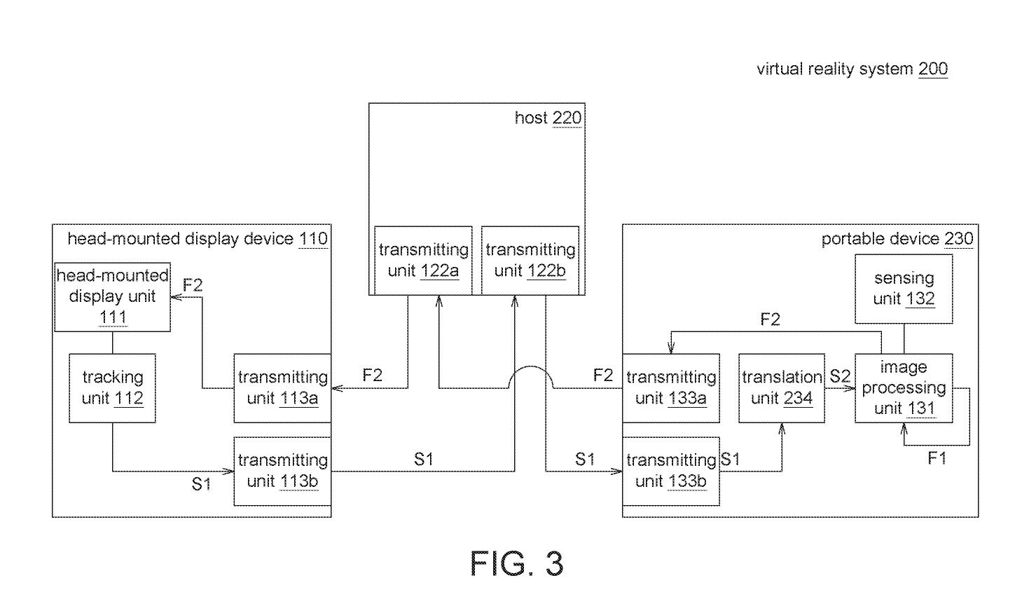

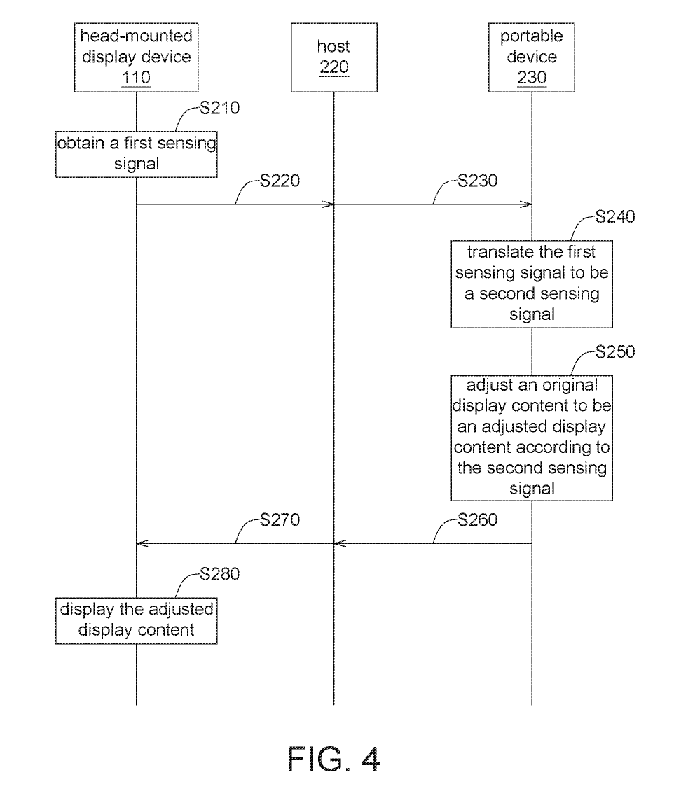

Refer to FIG. 3 and FIG. 4. FIG. 3 is a block diagram of a virtual reality system 200 according to another embodiment of the invention. FIG. 4 is a flowchart of a controlling method of the virtual reality system 200 according to another embodiment of the invention. In the present embodiment, the translation unit 234 is disposed within the portable device 230, and the similarities are not repeated here. The translation unit 234 disposed within the portable device 230 can also translate the first sensing signal S1 to be the second sensing signal S2.

As indicated in FIG. 4, the method proceeds to step S210, the first sensing signal S1 is obtained by the tracking unit 112 of the head-mounted display device 110.

Then, the method proceeds to step S220, the first sensing signal S1 is transmitted to the host 220 by the head-mounted display device 110.

After that, the method proceeds to step S230, the first sensing signal S1 is transmitted to the portable device 230 by the host 220.

Then, the method proceeds to step S240, the first sensing signal S1 is translated to be the second sensing signal S2 by the translation unit 234 of the portable device 230.

After that, the method proceeds to step S250, the original display content F1 is adjusted to be an adjusted display content F2 by the image processing unit 131 of the portable device 230 according to the second sensing signal S2.

Then, the method proceeds to step S260, the adjusted display content F2 is transmitted to the host 220 by the portable device 230.

After that, the method proceeds to step S270, the adjusted display content F2 is transmitted to the head-mounted display device 110 by the host 220.

Then, the method proceeds to step S280, the adjusted display content F2 is displayed by the head-mounted display unit 111 of the head-mounted display device 110.

In the present embodiment, the tracking step (step S210) is performed by the head-mounted display device 110; the translating step (step S240) and the display content adjusting step (step S250) are performed by the portable device 230. Or, several image processing units are disposed within the host 220, the portable device 130 and the head-mounted display device 110 to achieve optimum efficiency and quality of signal transmission. The head-mounted display device 110, the host 220 and the portable device 230 together complete the operations of the virtual reality system 200.

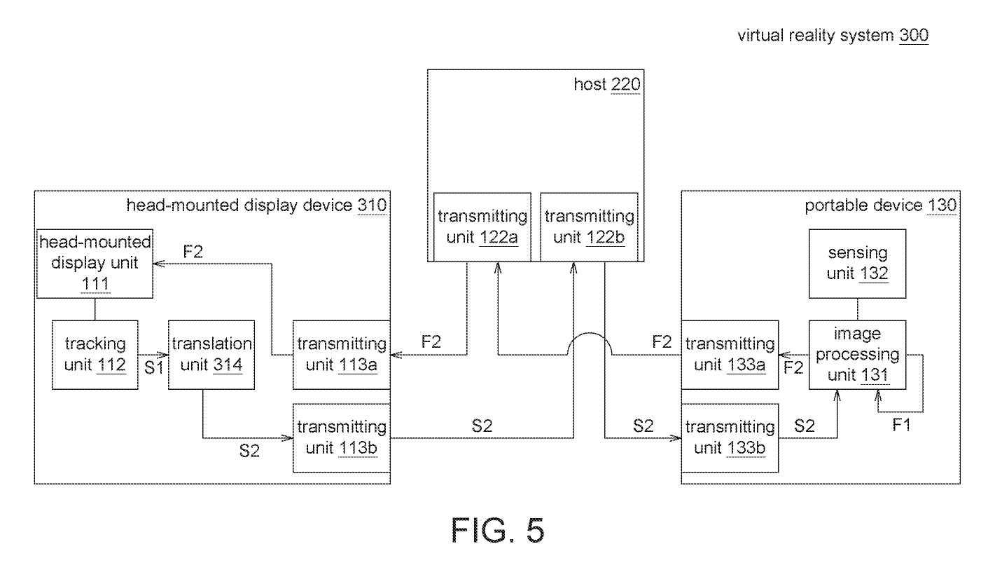

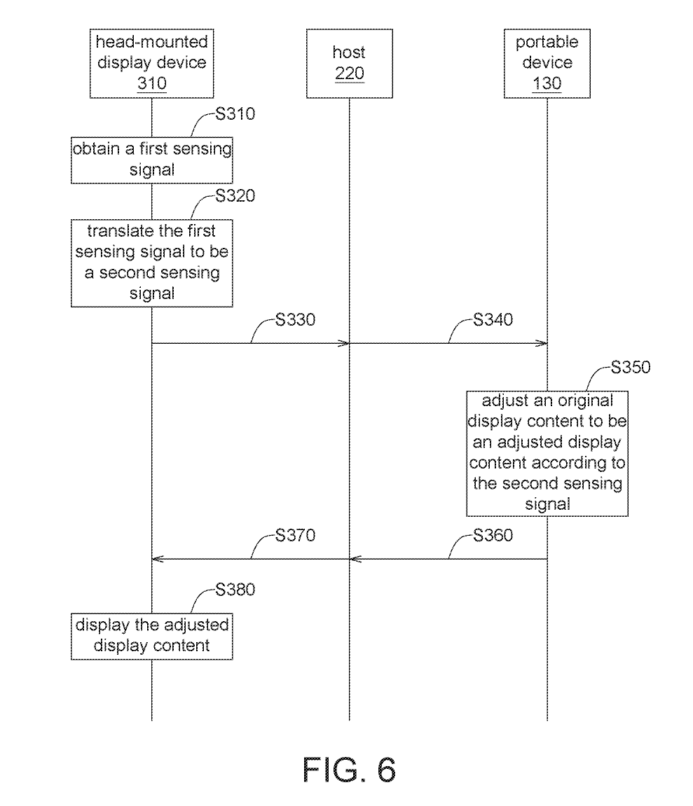

Refer a FIG. 5 and FIG. 6. FIG. 5 is a block diagram of a virtual reality system 300 according to another embodiment of the invention. FIG. 6 is a flowchart of a controlling method of the virtual reality system 300 according to another embodiment of the invention. In the present embodiment, the translation unit 314 is disposed within the head-mounted display device 310, and the similarities are not repeated here. The translation unit 314 disposed within the head-mounted display device 310 also can translate the first sensing signal S1 to be the second sensing signal S2.

As indicated in FIG. 6, the method proceeds to step S310, the first sensing signal S1 is obtained by the tracking unit 112 of the head-mounted display device 310.

Then, the method proceeds to step S320, the first sensing signal S1 is translated to be the second sensing signal S2 by the translation unit 314 of the head-mounted display device 310.

After that, the method proceeds to step S330, the second sensing signal S2 is transmitted to the host 220 by the head-mounted display device 110.

Then, the method proceeds to step S340, the second sensing signal S2 is transmitted to the portable device 130 by the host 220.

After that, the method proceeds to step S350, the original display content F1 is adjusted to be the adjusted display content F2 by the image processing unit 131 of the portable device 130 according to the second sensing signal S2.

Then, the method proceeds to step S360, the adjusted display content F2 is transmitted to the host 220 by the portable device 130.

After that, the method proceeds to step S370, the adjusted display content F2 is transmitted to the head-mounted display device 310 by the host 220.

Then, the method proceeds to step S380, the adjusted display content F2 is displayed by the head-mounted display unit 111 of the head-mounted display device 310.

In the present embodiment, the tracking step (step S310) and the translating step (step S320) are performed by the head-mounted display device 310; the display content adjusting step (step S350) is performed by the portable device 130. The head-mounted display device 310, the host 220 and the portable device 130 together complete the operations of the virtual reality system 300. Or, several image processing units are disposed within the host 220, the portable device 130 and the head-mounted display device 310 to achieve optimum efficiency and quality of signal transmission.

As disclosed in above embodiments, the user does not really move or rotate the portable device, but the portable device may adjust the original display content according to the movement or rotation of the head-mounted display device. The virtual reality system of the present disclosure combines the advantage of the portable device having versatile display resources and the advantage of the head-mounted display device having high performance in image resolution and high signal tracking and sensing, such that the application fields of the virtual reality system are even wider.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A controlling method of a virtual reality system, comprising:
obtaining a first sensing signal by a head-mounted display device;
translating the first sensing signal to be a second sensing signal;
adjusting an original display content to be an adjusted display content by a portable device according to the second sensing signal;
transmitting the adjusted display content to the head-mounted display device; and
displaying the adjusted display content by the head-mounted display device.

2. The controlling method of the virtual reality system according to claim 1, wherein the step of translating the first sensing signal to be the second sensing signal is performed by the head-mounted display device.

3. The controlling method of the virtual reality system according to claim 1, wherein the step of translating the first sensing signal to be the second sensing signal is performed by a host.

4. The controlling method of the virtual reality system according to claim 1, wherein the step of translating the first sensing signal to be the second sensing signal is performed by the portable device.

5. The controlling method of the virtual reality system according to claim 1, wherein the second sensing signal is a simulation signal of a sensing unit of the portable device.

6. A virtual reality system, comprising:
a head-mounted display unit;
a tracking unit for obtaining a first sensing signal;
a translation unit for translating the first sensing signal to be a second sensing signal; and
an image processing unit for adjusting an original display content to be an adjusted display content according to the second sensing signal;
wherein the head-mounted display unit and the tracking unit are disposed within the head-mounted display device, the image processing unit is disposed within a portable device, and the adjusted display content is transmitted to the head-mounted display unit, such that the head-mounted display unit displays the adjusted display content.

7. The virtual reality system according to claim 6, wherein the translation unit is disposed within the head-mounted display device.

8. The virtual reality system according to claim 6, wherein the translation unit is disposed within a host.

9. The virtual reality system according to claim 6, wherein the translation unit is disposed within the portable device.

10. The virtual reality system according to claim 6, wherein the second sensing signal is a simulation signal of a sensing unit of the portable device.

11. A head-mounted display device, comprising:
a head-mounted display unit;
a tracking unit for obtaining a first sensing signal; and
a translation unit for translating the first sensing signal to be a second sensing signal; and
a transmitting unit for transmitting the second sensing signal to a portable device, such that an original display content is adjusted to be an adjusted display content according to the second sensing signal, wherein the transmitting unit further receives the adjusted display content, such that the head-mounted display unit displays the adjusted display content.

12. The head-mounted display device according to claim 11, wherein the second sensing signal is a simulation signal of a sensing unit of the portable device.

13. A host, comprising:
a transmitting unit for receiving a first sensing signal of a head-mounted display device; and
a translation unit for translating the first sensing signal to be a second sensing signal;
wherein the transmitting unit further transmits the second sensing signal to a portable device, the portable device adjusts an original display content to be an adjusted display content according to the second sensing signal, the transmitting unit further transmits the adjusted display content to the head-mounted display device, such that the head-mounted display device displays the adjusted display content.

14. The host according to claim 13, wherein the second sensing signal is a simulation signal of a sensing unit of the portable device.

15. A portable device, comprising:
a transmitting unit for receiving a first sensing signal of a head-mounted display device;
a translation unit for translating the first sensing signal to be a second sensing signal; and
an image processing unit for adjusting an original display content to be an adjusted display content according to the second sensing signal;
wherein the transmitting unit further transmits the adjusted display content to the head-mounted display device, such that the head-mounted display device displays the adjusted display content.

16. The portable device according to claim 15, further comprising:
a sensing unit, wherein the second sensing signal is a simulation signal of the sensing unit of the portable device.
